(19) United States
(12) Patent Application Publication
(10) Pub. No.: US 2026/0050451 A1
(43) Pub. Date: Feb. 19, 2026

(54) CLASSIFYING AND SAMPLING EXECUTION EFFICIENCIES OF SOFTWARE LIBRARIES

(71) Applicant: INTERNATIONAL BUSINESS MACHINES CORPORATION, Armonk, NY (US)

(72) Inventors: Nicholas R. JONES, Poughkeepsie, NY (US); Brenton BELMAR, Poughkeepsie, NY (US); Jonathan D. BRADBURY, POUGHKEEPSIE, NY (US); Michael Joseph CADIGAN, JR., POUGHKEEPSIE, NY (US); Eberhard ENGLER, TUBINGEN (DE); Joseph GENTILE, WAPPINGERS FALLS, NY (US); Bruce Conrad GIAMEI, LAGRANGEVILLE, NY (US); Lisa Cranton HELLER, RHINEBECK, NY (US); Christian JACOBI, WEST PARK, NY (US); Edward A. KING, POUGHKEEPSIE, NY (US); Seth E. LEDERER, POUGHKEEPSIE, NY (US); Cedric LICHTENAU, STUTTGART (DE); Gary S. PUCHKOFF, POUGHKEEPSIE, NY (US); Andrew M. SICA, OXFORD, CT (US); Timothy J. SLEGEL, STAATSBURG, NY (US); Robert W. ST. JOHN, HYDE PARK, NY (US); Kevin A. STOODLEY, RICHMOND HILL (CA); Elpida TZORTZATOS, LAGRANGEVILLE, NY (US)

(21) Appl. No.: 18/802,183

(22) Filed: Aug. 13, 2024

(51) Int. Cl. G06F 9/445

(52) U.S. Cl. CPC G06F 9/44521

(57) ABSTRACT

Execution of an instruction includes obtaining software objects and loading instructions into a memory and storing the workload type attribute for each software object. The execution includes operations that during runtime, deploy a first hardware instruction to trigger a firmware process to sample, at each interval of timed pre-configured intervals, instructions from the sets of instructions of the one or more software objects being executed during the interval by one or more processors of the computing system. The operations include deploying a second hardware instruction to obtain and store samples from the firmware process in the memory. The operations include generating, based on analyzing the stored samples, execution parameters associated with each sample. The operations include determining accesses to the software libraries in the computing system, by workload type attribute. The operations automatically implement an action related to at least one software object in the computing system.

### BACKGROUND

One or more aspects relate, in general, to facilitating processing within a computing environment, and in particular, to improving such processing.

A computer system can execute numerous programs simultaneously. In executing various programs, program code can make calls to software libraries to perform essential functions. A software library contains reusable routines, which consist of sets of instructions loaded into memory. While it is possible for the operating system (OS) to track how often a program has access to the central processing unit (CPU), it is not as easy to track how often a software library has access to the CPU, because a software library can be invoked by multiple programs.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one computing device to perform computer operations. The computer operations include obtaining one or more software objects, each comprising a workload type attribute and a software library comprising a set of instructions. The computer operations include loading the set of instructions for each software object into a memory of a computing system and storing the workload type attribute for each software object as metadata of the software library for the software object. During runtime of the computing system, the computer operations include deploying a first hardware instruction to trigger a firmware process to sample, at each interval of timed pre-configured intervals, instructions from the sets of instructions of the one or more software objects being executed during the interval by one or more processors of the computing system. The computer operations include deploying a second hardware instruction to obtain and store samples from the firmware process in the memory. The computer operations include generating, based on analyzing the stored samples, execution parameters associated with each sample. The computer operations include utilizing the execution parameters and the metadata to determine accesses to the software libraries in the computing system, by workload type attribute. Based on determining the accesses, the computer operations include automatically implementing an action related to at least one software object in the computing system.

Shortcomings of the prior art are overcome, and additional advantages are provided through the provision of a computer-implemented method. The method includes obtaining one or more software objects, each comprising a workload type attribute and a software library comprising a set of instructions. The method includes loading the set of instructions for each software object into a memory of a computing system and storing the workload type attribute for each software object as metadata of the software library for the software object. During runtime of the computing system, the method includes deploying a first hardware instruction to trigger a firmware process to sample, at each interval of timed pre-configured intervals, instructions from the sets of instructions of the one or more software objects being executed during the interval by one or more processors of the computing system. The method includes deploying a second hardware instruction to obtain and store samples from the firmware process in the memory. The method includes generating, based on analyzing the stored samples, execution parameters associated with each sample. The method includes utilizing the execution parameters and the metadata to determine accesses to the software libraries in the computing system, by workload type attribute. Based on determining the accesses, the method includes automatically implementing an action related to at least one software object in the computing system.

Shortcomings of the prior art are overcome, and additional advantages are provided through the provision of a system. The system includes: a memory, one or more processors in communication with the memory, and program instructions executable by the one or more processors via the memory to perform a method. The method includes obtaining one or more software objects, each comprising a workload type attribute and a software library comprising a set of instructions. The method includes loading the set of instructions for each software object into a memory of a computing system and storing the workload type attribute for each software object as metadata of the software library for the software object. During runtime of the computing system, the method includes deploying a first hardware instruction to trigger a firmware process to sample, at each interval of timed pre-configured intervals, instructions from the sets of instructions of the one or more software objects being executed during the interval by one or more processors of the computing system. The method includes deploying a second hardware instruction to obtain and store samples from the firmware process in the memory. The method includes generating, based on analyzing the stored samples, execution parameters associated with each sample. The method includes utilizing the execution parameters and the metadata to determine accesses to the software libraries in the computing system, by workload type attribute. Based on determining the accesses, the method includes automatically implementing an action related to at least one software object in the computing system.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another.

Each of the embodiments of the computer program product may be combinable with aspects and/or embodiments of each computer system and/or computer-implemented method, and vice-versa. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present disclosure;

FIG. 2 depicts one example of further details of a processor of the processor set of FIG. 1, in accordance with one or more aspects of the present disclosure;

FIG. 3 depicts one example of a computing environment to incorporate and use one or more aspects of the present disclosure;

FIGS. 4A-4B depicts certain components of a computing environment to incorporate and use one or more aspects of the present disclosure;

FIG. 5 depicts a workflow comprising various aspects in accordance with one or more aspects of the present disclosure;

FIGS. 6A-6B depict another example of a computing environment to incorporate and use one or more aspects of the present disclosure.

### DETAILED DESCRIPTION

Examples herein include computer program products, computer-implemented methods, and computing systems, in which program code executing on one or more processors generates and provides data that enables continuous and efficient processing within a computing architecture, including a distributed computing architecture, such as a cloud computing environment. The data generated by program code in the examples herein pertains to the execution efficiency of software libraries. In these examples, machine code (e.g., firmware) and program code classify instructions that reside on disk or in a memory and provide these classifications in samples that can be tabulated into a report and/or utilized to implement processing decisions that maintain the efficacy and efficiency of the computing environment.

The program code in examples herein can both classify as well as sample the execution efficiency of software libraries and utilize these data to adjust access attributes for cloud consumers and/or performance of the libraries and of the computing environment. Based on software utilization, the program code can allocate and/or reclaim resources to support services provided that utilize these libraries. Thus, by generating data reflecting usage, the program code can manage the resources of the computing system efficiently and optimize processing within the processing environment.

In some examples, program code executing on one or more processors can classify software libraries and sample their execution frequency. A software library executing on the system can include a pre-defined attribute designating a workload class. In some examples, a vendor of the software library can pre-configure this attribute, which is installed together with the software in the processing environment. For example, when program code (e.g., of a program loader) fetches the software library, the program code can read the attribute comprising workload class details from the software library and apply the workload class to a memory that the software library is loaded into. When an application executes the software, machine code (e.g., firmware) can sample the running instruction and obtain and store the instruction details along with the workload classification details in the sample. The sample can be collected by program code executing on the machine (e.g., a resource of the computing environment). For example, in a distributed computing environment where a dispatcher manages a set of associated services, performing activities such as routing requests to these services, as well as managing their configuration at run time, this dispatcher can run a work unit from a work queue and create an interrupt. Based on the interrupt, the program code utilizes job step timing to collect the sample (if it is available). The program code can collect various samples in this manner over pre-defined intervals or over time, or based on pre-defined triggers, and the program code can count the samples collected on a per workload class basis (based on the library attribute). The program code can aggregate these counts into system management facility (SMF) records.

The examples herein enable the functionality described in a transparent manner and within the confines of the existing technical architecture of the system without adversely impacting system performance. As will be described in greater detail herein, the examples herein enable program code and/or machine code to classify metadata associated with the system's memory where instructions are loaded. In a non-limiting example, translation tables can store memory metadata, including metadata related to software libraries. An example of a computing system that utilizes tables in this manner, specifically DAT (Dynamic Address Translation) tables, is the z/Architecture instruction set architecture that is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities may include and/or use one or more aspects of the present invention. z/Architecture and IBM are trademarks or registered trademarks of International Business Machines Corporation in at least one jurisdiction.

The examples herein include computer-implemented methods, computer program products, and computer systems, where program code and/or machine code determine execution frequency (e.g., CPU or processor accesses) to software libraries and can utilize this information to generate reports and/or tune resources of the computing system. Included in the computer operations are taking a sample at a predetermined interval in firmware. In some examples, each program has a workload class assigned stored in memory (e.g., a DAT structure) which is determined at link time by a binder. At a (e.g., second) interval, the program code can collect the samples are collected (e.g., as described herein an initial interval is a dispatch interval which occurs in response to an interrupt). The program code can aggregated these samples to generate a report of how much relative time (percentage) was spent in each workload class and can also utilize these data to (e.g., automatically) tune system resources.

The examples herein are inextricably tied to computing and are directed to a practical application. When an OS tracks and categorizes execution time on a software library basis, the OS can report on CPU usage at a software library or group of software libraries basis and can allocate and reclaim resources in accordance with usage, optimizing processing. Additionally, these data can be utilized for allocating resources to software in a distributed computing environment, including in a cloud computing environment. The examples herein are directed to the practical application of generating data related to execution time on a software library basis and utilizing these data to maintain and/or improve performance of a distributed computing system, including allocating resources in a manner that optimizing processing. These examples are inextricably tied to computing at least because the utilization of software libraries and resource allocation and utilization to maintain processing efficacy and efficiency are elements that are exclusive to computing.

The examples herein provide significantly more than other approaches of generating data related to execution time on a software library basis and utilizing these data to maintain and/or improve performance of a distributed computing system. As will be discussed herein, the approach proposed herein for generating and utilizing data related to execution time on a software library basis, unlike existing approaches, does not degrade the performance of the computing system. In many of the examples herein, to generate these data, program code samples instructions, including at pre-defined intervals, to provide a view of the running work of the processing resources of the computing environment. Collected over time, these samples provide a representative view of software running executing the system, at a frequency that does not impede performance, but provides a representative distribution of samples over each interval. Existing approaches degrade the performance of the computing system to provide data which can be more granular but is not more usable for the practical applications discussed herein. For example, in some existing approaches upon which the examples herein improve, a software library can keep track of how much CPU time it spends during operation with changes to the software library code based on the computing system running a service to determine how much time the software had access to CPU between two points in a software library. This existing approach degrades production because not only does it require the addition of code to collect the data and report on it, but the service of the approach utilizes additional processing resources to run. In contrast, the examples herein enable program code and/or machine code to transparently obtain and generate data related CPU usage data on software libraries without making code changes to the software libraries and without degrading performance of the system.

The examples herein include computer-implemented methods, computer program products, and computer systems. Certain of the computer program products disclosed herein include a set of one or more computer-readable storage media and program instructions, collectively stored in the set of one or more computer-readable storage media, for causing at least one computing device to perform computer operations. The computer operations include obtaining one or more software objects, each comprising a workload type attribute and a software library comprising a set of instructions. The computer operations include loading the set of instructions for each software object into a memory of a computing system and storing the workload type attribute for each software object as metadata of the software library for the software object. During runtime of the computing system, the computer operations include deploying a first hardware instruction to trigger a firmware process to sample, at each interval of timed pre-configured intervals, instructions from the sets of instructions of the one or more software objects being executed during the interval by one or more processors of the computing system. The computer operations include deploying a second hardware instruction to obtain and store samples from the firmware process in the memory. The computer operations include generating, based on analyzing the stored samples, execution parameters associated with each sample. The computer operations include utilizing the execution parameters and the metadata to determine accesses to the software libraries in the computing system, by workload type attribute. Based on determining the accesses, the computer operations include automatically implementing an action related to at least one software object in the computing system. Hence, the examples herein enable program code and/or machine code to transparently obtain and generate data related CPU usage data on software libraries without making code changes to the software libraries and without degrading performance of the system.

Additionally or alternatively, the computer operations can include generating the one or more software objects. The generating can comprise, for each software object, obtaining the object code of the software library from a storage medium, analyzing the object code to determine a workload type attribute, and utilizing a binder to link the object code to the workload type attribute, where the object code with the linked workload type attribute comprises the software object. Including an attribute with a software object such that it can be loaded when the software is deployed, allows the attribute to be retained (e.g., as metadata) within the existing architecture of the system, which enables program code to obtain access information based on software attributes without degrading performance of the system. The availability of attribute information enables this granular detail in reporting and enables management mechanisms within the system to utilize this information in resource allocation (e.g., to optimize performance).

Additionally or alternatively, the workload type attribute can indicate a workload class of the software library. As noted above, including an attribute with a software object such that it can be loaded when the software is deployed, allows the attribute to be retained (e.g., as metadata) within the existing architecture of the system, which enables program code to obtain access information based on software attributes without degrading performance of the system. The availability of attribute information enables this granular detail in reporting and enables management mechanisms within the system to utilize this information in resource allocation (e.g., to optimize performance). Workload class is a software attribute that can be particularly helpful to resource allocation decisions.

Additionally or alternatively, deploying the second hardware instruction to obtain and store samples from the firmware process in the memory can include determining an interrupt has occurred. Based on determining that the interrupt has occurred, controlling a second firmware process to issue and extract instruction to collect pending samples. The sampling of software access information by the system is transparent both because the examples herein can be implemented within the existing technical architecture and because the sampling can take advantage of existing interrupts, when available, and trigger interrupts itself when an existing interrupt is not available, thus limiting any adverse impacts on system performance.

Additionally or alternatively, the action comprises generating and transmitting a report based on the generated execution parameters. As discussed above, the execution parameters provide information on software object access that enables resource allocation and other processing decisions to be made in a manner that optimizes resource allocation.

Additionally or alternatively, the action can include automatically adjusting allocation of a resource of the computing system based on the generated execution parameters. Adjusting allocations can optimize the computing system and improve performance.

Additionally or alternatively, storing the workload type attribute can include storing the workload type attribute in a dynamic address translation table. By utilizing existing elements of an architecture to store information that assists in optimization, the examples herein improve performance without initially compromising performance.

Additionally or alternatively, the second hardware instruction can control a second firmware process to obtain and store the samples from the firmware process at a second pre-determined interval. By utilizing existing elements of an architecture to store information that assists in optimization, the examples herein improve performance without initially compromising performance.

Additionally or alternatively, the execution parameters for each software library can each comprise an indication of an amount of time the software library was accessed by a processor of the one or more processors or the computing system. By utilizing existing elements of an architecture to store information that assists in optimization, the examples herein improve performance without initially compromising performance.

Additionally or alternatively, the second firmware process can determines, at each second pre-determined, if a sample was taken by the firmware process during the second pre-determined interval, and based on determining that the sample was taken, the process can increment a count associated with the workload class in the sample. The sampling of software access information by the system is transparent both because the examples herein can be implemented within the existing technical architecture and because the sampling can take advantage of existing interrupts, when available, and trigger interrupts itself when an existing interrupt is not available, thus limiting any adverse impacts on system performance.

In some examples, herein, a computer-implemented method includes obtaining one or more software objects, each comprising a workload type attribute and a software library comprising a set of instructions. The method includes loading the set of instructions for each software object into a memory of a computing system and storing the workload type attribute for each software object as metadata of the software library for the software object. During runtime of the computing system, the method includes deploying a first hardware instruction to trigger a firmware process to sample, at each interval of timed pre-configured intervals, instructions from the sets of instructions of the one or more software objects being executed during the interval by one or more processors of the computing system. The method includes deploying a second hardware instruction to obtain and store samples from the firmware process in the memory. The method includes generating, based on analyzing the stored samples, execution parameters associated with each sample. The method includes utilizing the execution parameters and the metadata to determine accesses to the software libraries in the computing system, by workload type attribute. Based on determining the accesses, the method includes automatically implementing an action related to at least one software object in the computing system. Hence, the examples herein enable program code and/or machine code to transparently obtain and generate data related CPU usage data on software libraries without making code changes to the software libraries and without degrading performance of the system.

Additionally or alternatively, the method can include generating the one or more software objects. The generating can comprise, for each software object, obtaining the object code of the software library from a storage medium, analyzing the object code to determine a workload type attribute, and utilizing a binder to link the object code to the workload type attribute, where the object code with the linked workload type attribute comprises the software object. Including an attribute with a software object such that it can be loaded when the software is deployed, allows the attribute to be retained (e.g., as metadata) within the existing architecture of the system, which enables program code to obtain access information based on software attributes without degrading performance of the system. The availability of attribute information enables this granular detail in reporting and enables management mechanisms within the system to utilize this information in resource allocation (e.g., to optimize performance).

Additionally or alternatively, the workload type attribute can indicate a workload class of the software library. As noted above, including an attribute with a software object such that it can be loaded when the software is deployed, allows the attribute to be retained (e.g., as metadata) within the existing architecture of the system, which enables program code to obtain access information based on software attributes without degrading performance of the system. The availability of attribute information enables this granular detail in reporting and enables management mechanisms within the system to utilize this information in resource allocation (e.g., to optimize performance). Workload class is a software attribute that can be particularly helpful to resource allocation decisions.

Additionally or alternatively, deploying the second hardware instruction to obtain and store samples from the firmware process in the memory can include determining an interrupt has occurred. Based on determining that the interrupt has occurred, controlling a second firmware process to issue and extract instruction to collect pending samples. The sampling of software access information by the system is transparent both because the examples herein can be implemented within the existing technical architecture and because the sampling can take advantage of existing interrupts, when available, and trigger interrupts itself when an existing interrupt is not available, thus limiting any adverse impacts on system performance.

Additionally or alternatively, the action comprises generating and transmitting a report based on the generated execution parameters. As discussed above, the execution parameters provide information on software object access that enables resource allocation and other processing decisions to be made in a manner that optimizes resource allocation.

Additionally or alternatively, the action can include automatically adjusting allocation of a resource of the computing system based on the generated execution parameters. Adjusting allocations can optimize the computing system and improve performance.

Additionally or alternatively, storing the workload type attribute can include storing the workload type attribute in a dynamic address translation table. By utilizing existing elements of an architecture to store information that assists in optimization, the examples herein improve performance without initially compromising performance.

Additionally or alternatively, the second hardware instruction can control a second firmware process to obtain and store the samples from the firmware process at a second pre-determined interval. By utilizing existing elements of an architecture to store information that assists in optimization, the examples herein improve performance without initially compromising performance.

Additionally or alternatively, the execution parameters for each software library can each comprise an indication of an amount of time the software library was accessed by a processor of the one or more processors or the computing system. By utilizing existing elements of an architecture to store information that assists in optimization, the examples herein improve performance without initially compromising performance.

Additionally or alternatively, the second firmware process can determines, at each second pre-determined, if a sample was taken by the firmware process during the second pre-determined interval, and based on determining that the sample was taken, the process can increment a count associated with the workload class in the sample. The sampling of software access information by the system is transparent both because the examples herein can be implemented within the existing technical architecture and because the sampling can take advantage of existing interrupts, when available, and trigger interrupts itself when an existing interrupt is not available, thus limiting any adverse impacts on system performance.

The computer systems described herein can include a memory, one or more processors in communication with the memory, and program instructions executable by the one or more processors via the memory to perform a method. The method includes obtaining one or more software objects, each comprising a workload type attribute and a software library comprising a set of instructions. The method includes loading the set of instructions for each software object into a memory of a computing system and storing the workload type attribute for each software object as metadata of the software library for the software object. During runtime of the computing system, the method includes deploying a first hardware instruction to trigger a firmware process to sample, at each interval of timed pre-configured intervals, instructions from the sets of instructions of the one or more software objects being executed during the interval by one or more processors of the computing system. The method includes deploying a second hardware instruction to obtain and store samples from the firmware process in the memory. The method includes generating, based on analyzing the stored samples, execution parameters associated with each sample. The method includes utilizing the execution parameters and the metadata to determine accesses to the software libraries in the computing system, by workload type attribute. Based on determining the accesses, the method includes automatically implementing an action related to at least one software object in the computing system. Hence, the examples herein enable program code and/or machine code to transparently obtain and generate data related CPU usage data on software libraries without making code changes to the software libraries and without degrading performance of the system.

Additionally or alternatively, the method can include generating the one or more software objects. The generating can comprise, for each software object, obtaining the object code of the software library from a storage medium, analyzing the object code to determine a workload type attribute, and utilizing a binder to link the object code to the workload type attribute, where the object code with the linked workload type attribute comprises the software object. Including an attribute with a software object such that it can be loaded when the software is deployed, allows the attribute to be retained (e.g., as metadata) within the existing architecture of the system, which enables program code to obtain access information based on software attributes without degrading performance of the system. The availability of attribute information enables this granular detail in reporting and enables management mechanisms within the system to utilize this information in resource allocation (e.g., to optimize performance).

Additionally or alternatively, the workload type attribute can indicate a workload class of the software library. As noted above, including an attribute with a software object such that it can be loaded when the software is deployed, allows the attribute to be retained (e.g., as metadata) within the existing architecture of the system, which enables program code to obtain access information based on software attributes without degrading performance of the system. The availability of attribute information enables this granular detail in reporting and enables management mechanisms within the system to utilize this information in resource allocation (e.g., to optimize performance). Workload class is a software attribute that can be particularly helpful to resource allocation decisions.

Additionally or alternatively, deploying the second hardware instruction to obtain and store samples from the firmware process in the memory can include determining an interrupt has occurred. Based on determining that the interrupt has occurred, controlling a second firmware process to issue and extract instruction to collect pending samples. The sampling of software access information by the system is transparent both because the examples herein can be implemented within the existing technical architecture and because the sampling can take advantage of existing interrupts, when available, and trigger interrupts itself when an existing interrupt is not available, thus limiting any adverse impacts on system performance.

Additionally or alternatively, the action comprises generating and transmitting a report based on the generated execution parameters. As discussed above, the execution parameters provide information on software object access that enables resource allocation and other processing decisions to be made in a manner that optimizes resource allocation.

Additionally or alternatively, the action can include automatically adjusting allocation of a resource of the computing system based on the generated execution parameters. Adjusting allocations can optimize the computing system and improve performance.

Additionally or alternatively, storing the workload type attribute can include storing the workload type attribute in a dynamic address translation table. By utilizing existing elements of an architecture to store information that assists in optimization, the examples herein improve performance without initially compromising performance.

Additionally or alternatively, the second hardware instruction can control a second firmware process to obtain and store the samples from the firmware process at a second pre-determined interval. By utilizing existing elements of an architecture to store information that assists in optimization, the examples herein improve performance without initially compromising performance.

Additionally or alternatively, the execution parameters for each software library can each comprise an indication of an amount of time the software library was accessed by a processor of the one or more processors or the computing system. By utilizing existing elements of an architecture to store information that assists in optimization, the examples herein improve performance without initially compromising performance.

Additionally or alternatively, the second firmware process can determines, at each second pre-determined, if a sample was taken by the firmware process during the second pre-determined interval, and based on determining that the sample was taken, the process can increment a count associated with the workload class in the sample. The sampling of software access information by the system is transparent both because the examples herein can be implemented within the existing technical architecture and because the sampling can take advantage of existing interrupts, when available, and trigger interrupts itself when an existing interrupt is not available, thus limiting any adverse impacts on system performance.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that performs control mode processing including selective control mode processing and/or one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

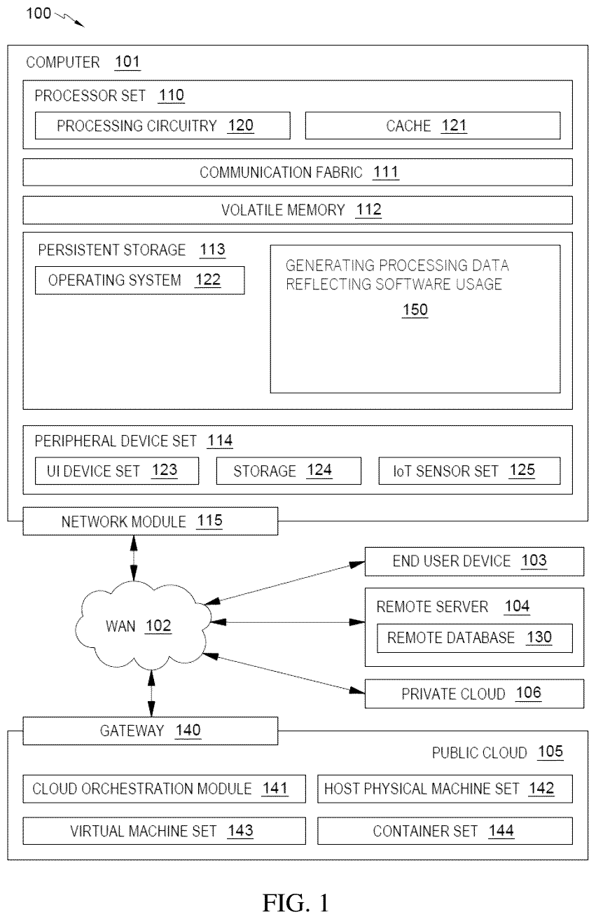

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as generating processing (e.g., CPU) data reflecting software usage (without compromising performance or implementing technical architecture changes) 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

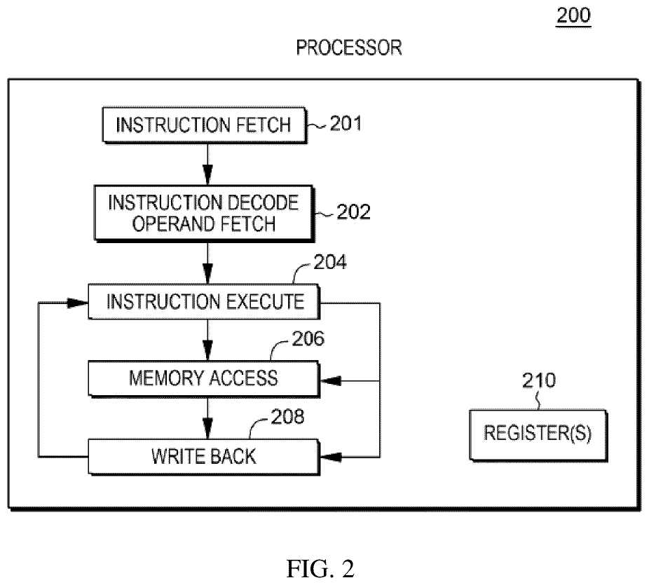

In one example, a processor (e.g., of processor set 110) includes a plurality of functional components (or a subset thereof) used to execute instructions. As depicted in FIG. 2, in one example, a processor 200 includes, for instance, an instruction fetch component 201 to fetch instructions to be executed; an instruction decode/operand fetch component 202 to decode the fetched instructions and to obtain operands of the decoded instructions; one or more instruction execute components 204 to execute the decoded instructions; a memory access component 206 to access memory for instruction execution, if necessary; and a write back component 208 to provide the results of the executed instructions. One or more of the components may access and/or use one or more registers 210 in instruction processing. Further, one or more of the components may access and/or use processing code to generating processing (e.g., CPU) data reflecting software usage (without compromising performance or implementing technical architecture changes) and automatically implement changes based on these data 150. Additionally, fewer, and/or other components may be used in one or more aspects of the present disclosure.

As discussed above, in the examples herein, program code executing one or more processors and/or firmware generate and retain data and/or metadata related to accesses by one or more processors to the software libraries. The program code can utilize the data and metadata, for example, for allocation and processing to optimize resource usage within the computing environment. In the descriptions of the functionality in the examples herein, certain aspects are presented as individual modules. This configuration is a non-limiting example and is provided for illustrative purposes for ease of understanding. In various examples, various functionalities can be combined into one or more modules.

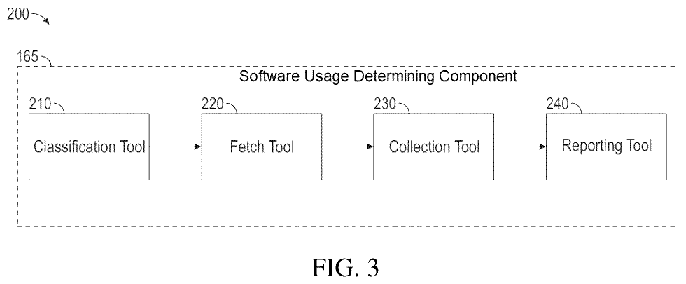

FIG. 3 illustrates various aspects of program code, which can include software and/or hardware, tracking processors accesses to software libraries. However, to enable this tracking and analysis, software libraries are generated and installed by program code with classification attributes that can be utilized by the processes described in FIG. 3. For example, when program code executing on one or more processors generate a software library, during a binding operation, where groups of object code are linked together, program code generated the software library from the existing object code and adds one or more classification attributes. As aforementioned, the functionality described herein is implemented transparently and without degrading processing, hence, there is no change to the instructions or the object code. The program code implements the attributes such that these classification attributes are in the software library and thus, available for the loader. When program code (e.g., comprising a loader) loads a software library into a computing environment, from disk into memory, the program code comprising the loader applies the classification attribute(s) to the memory that the software libraries instructions are loaded into. Hence, the classification become part of the metadata associated with the memory (e.g., in a DAT table). When firmware samples an instruction, the firmware records a sample of a current running instruction every period (e.g., a pre-configured period, which can be a millisecond). The sample include the classification attribute(s) from the memory (e.g., from a DAT table entry associated with the running instruction address). The sampling can be managed by program code comprising a dispatcher, which virtualizes and allocates access to CPU for the various programs running on the system. During the dispatcher operations, the dispatcher can query if a new sample has been taken, and if a new sample has been taken, the dispatcher will receive the sample buffer. The dispatcher can use the classification attributes from the sample buffer to increment a set of counts (e.g., counted can depend on the classification attributes, with a separate count for each classification attribute). Depending on the type of granularity that would help inform and/or automatically implement resource decisions, the program code can subdivide these data by program and/or address space. In the non-limiting example of an IBM z Systems, provided for illustrative purposes only, the program code can periodically collect these data (e.g., into SMF records) and integrate them into a report for use in allocating z/OS software and/or performing a system performance analysis.

Referring to FIG. 3, is a block diagram 300 that illustrates program code executing on one or more processors that interprets and/or generates usage efficiency data based on processor accesses of software libraries referred to herein as a software usage determining component 165. The software usage determining component 165 may include hardware, software, or combinations thereof. Here, the software usage component 165 includes, without limitation, a classification tool 210, a fetch tool 220, a monitoring and analysis tool 230, and a reporting tool 240. As aforementioned, the various functionalities are presented as modules for illustrative purposes only and this is a non-limiting configuration of various aspects described herein.

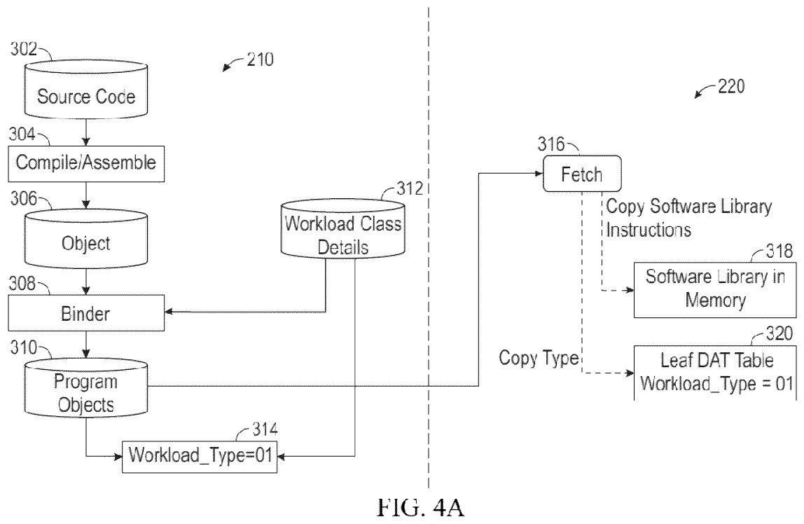

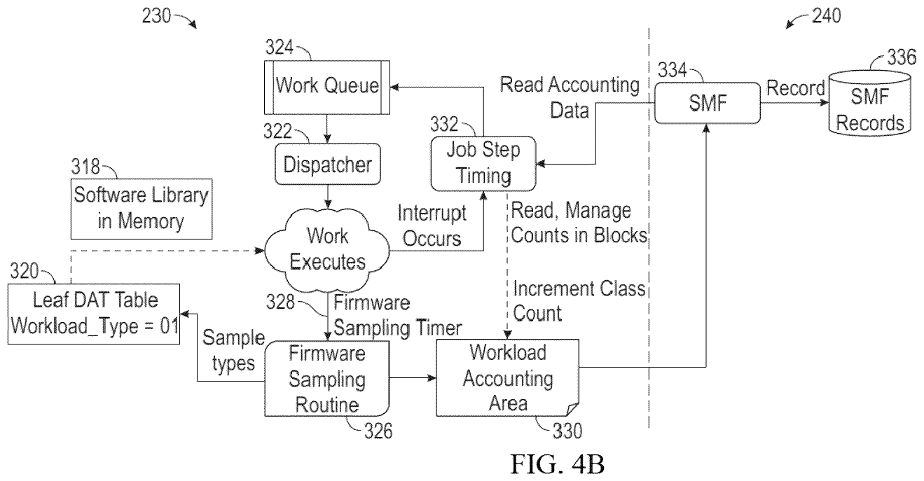

In some examples herein, program code of the classification tool 210 obtains a software object and associates a workload class identifier with the software object. The software object can include a set of software library instructions. The software object as well as the workload class identifier can be implemented manually into the object by a user (e.g., software developer/software vendor) and/or automatically derived based on characteristics of the software. For example, a software vendor and/or process can produce source code, compile the source code to generate object code, and provide the object code along with a workload class identifier that indicates a workload type associated with the object code to the classification tool 210. As noted, such workload types can include database, analytics, artificial intelligence (AI)/cognitive/machine learning (ML) inferencing, web/content hosting, Internet of Things (IoT)/data streaming, mobile application/device backend, and security, as illustrative, non-limiting examples. The classification tool 210 can bind the object code and the workload class identifier together to generate a software object marked with the workload class identifier. The functionality of the program code comprising the classification tool 210 is described in greater detail herein with respect to FIG. 4A.

Once the software object is generated (and marked with the workload class identifier) program code comprising a fetch tool 220 can load instructions from a storage location (e.g., storage 113, storage 124, or another internal/external storage location) into memory (e.g., memory 112) of a computing system (e.g., computer 101). In some examples, the fetch tool 220 loads the software object (including the associated workload class identifier) generated by the classification tool 210 into memory for execution. Program code comprising the fetch tool 220 is described in greater detail herein with respect to FIG. 4A.

During runtime, program code comprising a monitoring and analysis tool 230 samples instructions being executed by one or more processors, generates execution parameters associated with the sample, and can store the execution parameters in a storage location. In some examples, the program code of the monitoring and analysis tool 230 utilizes a firmware sampling routine to periodically collect samples of the instructions being executed by the processor and utilizes a job collection timing routine to periodically instruct one or more processors to return a sample, if available, or an indication of no sample, if none is available. When the program code of the monitoring and analysis tool 230 obtains the sample, to perform the analysis (and interpretation) functionality of this aspect, the program code computes respective execution parameters for each available sample collected by the firmware sampling routine. In some examples, the program code provides these computations to program code comprising a reporting tool 240 is generally, which reports execution parameters for one or more workload class identifiers to another user, computing system, or combination thereof. For example, the program code of the reporting tool can provide results that trigger a processor to alter resource allocations to provide more resources to software libraries accessed more often by CPU. Both the program code of the monitoring and analysis tool 230 and the program code of the reporting tool 240 are described in greater detail herein with respect to FIG. 4B.

As noted earlier, block diagram 200 illustrates one example implementation of the software usage determining component 165 and that other implementations of the software usage determining component 165 are also contemplated. For example, the software usage determining component 165 is depicted as having a classification tool 210, a fetch tool 220, a monitoring and analysis tool 230, and a reporting tool 240, the software usage determining component 165 may be implemented with fewer or greater number of hardware/software components.

FIGS. 4A-4B further illustrate various aspects of the software usage determining component 165, depicted in FIG. 2, according to one embodiment. As aforementioned, the functionalities are represented as separate components for illustrative purposes only and not to suggest any limitations to configuration possibilities. Referring to FIG. 4A, a resource (e.g., user, software vendor, device) produces source code 302 and provides the source code 302 to a compiler or assembler 304. The compiler/assembler 304 compiles the source code 302 to generate object code 306. Rather than generate new object code, in some examples, the object code 306 utilizes pre-existing object code that program code executing on one or more processors in a computing environment obtains from a storage location (e.g., database) accessible to the one or more processors.

In the examples, herein, program code implements a link between the object code 306 and workload class information 312. As aforementioned, implementing the workload information in an existing structure so that one or more or program code and machine code can determine software library usage by processors without degrading performance or implementing changes to the existing system architecture. To link the workload class information 312 with the object code 306, program code can utilize a binder 308 to link the object code 306 and generate a software object 310 (or program object, which can include software libraries with workload type attributes). The software object 310, for example, can include a set of software library instructions and the workload class information 312. The workload class information 312 can include a workload class identifier 314 that indicates a type of workload (e.g., analytics, security, AI/ML, etc.) associated with the software object 310. As illustrated in FIG. 4A, in one implementation, program code executing on one or more processors can set the workload class identifier 314 to a value (e.g., integer value “XX”) that indicates a particular workload type of multiple workload types. While FIG. 4A depicts the workload class identifier 314 having an integer data type, other data types (e.g., alphanumeric data type, string data type, etc.) are also contemplated.

Creating a software object (e.g., software library) with a marked workload class identifier, enables program code in the examples herein to transparently collect CPU usage information on software libraries without implementing code changes in the object code or software libraries. In some examples, the program code generates a software object that includes software library instructions and a workload class identifier. As explained herein, based on the inclusion of the classifier, the program code or machine code can sample the object to gauge the execution frequency of software libraries with the same workload class type in comparison with software libraries associated with other workload class types. Based on these results, program code allocating resources to various services and processes can adjust allocations on a workload class basis to account for execution frequencies.

Program code comprising a fetch tool 220, as illustrated in FIG. 4A, includes program code comprising a fetch component 316 (e.g., software). As aforementioned the program objects include software libraries and workload type attributes. While program code comprising a fetch tool copies library instructions into a memory, the fetch tool can retain the workload type by copying it into a table (which can be separate from the memory where the instructions are loaded and from which they are executed). As illustrated in FIG. 4A, this program code, executing on one or more processors, loads the instructions from the software object 310 from a storage location (e.g., disk) into memory (e.g., memory 112) (block 318). In some examples, the software object 310 is installed at the computing system when the program code stores the software object 310 in a storage location accessible to the computing system. The program code comprising the fetch component 316 copies the software instructions from the storage location into memory (block 318). During the copy operation, program code comprising the fetch component 316 can also copy the workload class identifier 314 associated with the software object 310 into the same memory location as the software instructions. For example, the fetch component 316 can update the dynamic address translation (DAT) table entry 320 associated with the memory containing the instructions to assign the memory the desired workload class identifier 314. The program code can load the software object 310 into memory so that the software can be executed by a resource of the computing system, including by one or more processors. When the program code samples the software object 310, the sample includes the workload class identifier.

Based on the execution frequency of the library, a dispatcher 322 can change resource allocations within the computing system. The OS utilizes the dispatcher 322, as illustrated in FIG. 4AB, to allocate work in the computing system to the processor(s). Such work can include work units, tasks, threads of a running program (e.g., instructions), or a combination thereof. The dispatched 322 can add work queue 324, for example, in priority order. As the computing system is running, additional work can be generated and added to the work queue 324, run, and removed from the work queue 324. As work is completed, the work units may be removed or re-used for new work. FIG. 4AB illustrated the dispatcher 322 dispatching work (e.g., instructions) from one or more work queues 324 to a processor(s). The dispatcher 322 can run on each processor and can obtain work from a respective work queue 324 to execute. In some examples, as the dispatcher 322 obtains work to execute on a processor(s), a firmware sampling routine 326 (enabled by the OS) periodically samples (e.g., every n milliseconds) the current running instruction being executed on the processor(s). The firmware sampling routine 326 can obtain control from the processor(s) each time that the firmware sampling timer 328 indicates the occurrence of a predetermined time instance. In some examples, the firmware sampling routine 326 is a millicode sampling routine that is configured to periodically sample the current running instruction. The firmware sampling timer 328 can have a millisecond sampling rate, such that the firmware sampling routine 326 is invoked every n milliseconds. The sampling rate of the firmware sampling timer 328 can vary across different examples. By sampling at set intervals, the program code (e.g., firmware, millicode) performs sampling in a manner that promotes consistent processing speed and loading.

As aforementioned, in the examples herein, software and hardware components of a technical environment can work in concert to determine software library execution frequency as well as to implement configuration and allocation changes, as needed, to optimize the system and its resources, based on the execution frequency. A hardware component that participates in the workflows described herein is a firmware sampling timer 328 which can be configured with a sampling rate, such that the firmware sampling routine 326 receives control from a processor at a consistent interval. In some cases, this interval is be configured to be greater than the longest time slice of the dispatcher (e.g., the dispatcher may fetch instructions every n microseconds or nanoseconds), so that software usage determining component 165 can generate a representative sample distribution of execution parameters of the software libraries over a period of time while avoiding a degradation in system performance.

When the firmware sampling routine 326 receives control, program code executing a current running instruction can pause execution of the instruction. The firmware sampling routine 326 can record the instruction's memory location (e.g., instruction address) and other information, such as the workload class information 312 (including the workload class identifier 314) associated with the instruction's memory location, primary address space number, and state descriptions (e.g., addressing mode, DAT state, indication if the system is running in problem or supervisor state, etc.), as illustrative, non-limiting examples. The firmware sampling routine 326 can save the sample in a storage location, such as workload accounting area 330. In some examples, the workload accounting area 330 is a virtual memory that has been reserved from an address space for storing samples.

Because of the timing of the sampling performed by the firmware, in some examples, the firmware sampling routine 326 can record a new sample before the OS obtains the previous sample. In this situation, the program code can overwrite the old sample. The machine code of the firmware sampling routine 326 can save a count of samples or a count of missed samples, for the OS to analyze to determine if sample data has been lost. The machine code of the firmware sampling routine 326 can also generate a list of samples since a last request from the operating system and provide the list to the OS and/or to program code requesting this information.

Program code executing on the processor determine the execution frequency of libraries based on analyzing the samples obtained by the firmware routine. Referring to FIG. 4B, once the firmware sampling routine 326 has sampled an instruction, the processor (having received a request to execute the instruction initially from program cod) can continue to execute work (e.g., instructions) dispatched by the dispatcher 322. Each work unit can indicate which instruction address was last executed or which instruction address to continue to work on. As aforementioned, instruction execution can be paused when the firmware obtains a sample, thus, in some examples, the program code (executing on one or more processors) performs work until an interrupt occurs. These interrupts can be regular and controlled via the dispatcher 322 by a (CPU) timer. The CPU timer (set by the dispatcher) causes the computing system to take an interrupt after a predetermined period of time (e.g., a value on the order of microseconds) has elapsed. Hence, if a predetermined period of time (e.g., 150 microseconds) has elapsed and another interrupt (e.g., from processing of input/output (I/O) requests) has not been taken, the computing system can take an interrupt. In some examples, the CPU timer has smaller value than the firmware sampling routine frequency to ensure that the dispatcher receives the most samples. In some examples, the CPU timer has a larger value than the firmware sampling routine frequency.

As illustrated in FIG. 4B, when the CPU timer caused an interrupt, a job step timing routine 332 (e.g., a dispatcher routine) can record statistics from the last prior dispatch. The job step timing routine 332 can also issue a new CPU instruction to collect a sample (e.g., from the workload accounting area 330) if one is available. If a sample is not available, then the job step timing routine 332 takes no additional action, in some examples, and the dispatcher 322 continues dispatching work from the work queue 324. In some examples, the CPU instruction is in hardware (as opposed to in millicode) when a sample is not available. However, if a sample is available, then the job step timing routine 332 can obtain the sample and use the workload class information 312 associated with the sample to increment a set of counts.

The workload class type information was retained in the system from install through execution so that the execution frequency could be determines based on workload class types. To that end, each count in the set of counts can be associated with a respective workload class type. The job step timing routine 332 can increment the count associated with the workload class identifier 314 from the workload class information 312. The job step timing routine 332 can also subdivide counts by program or address space. The job step timing routine 332 can store the count information in the workload accounting area 330. As aforementioned, the examples herein utilize existing aspects of the technical architecture of the computing system to enable transparent implementation and processing-neutral execution.

As illustrated in FIG. 4B, the job step timing routine 332 can keep track of lost samples. For example, if the sample count is greater than one or the missed sample count is greater than zero, then the job step timing routine 332 can determine the number of samples that were not attributed to a workload class and can utilize this information to aid in debugging.

Once software usage has been determined, the program code can report the results, which can be utilized, including automatically, to adjust resource allocation. The reporting aspects are also illustrated in FIG. 4B, which depict that the reporting tool 240 can use a system management facility (SMF) component 334 to report count information for a period of time. In some examples, program code comprising the SMF component 334 can periodically retrieve the count information and store the count information in a database 336.

In some examples, program code comprising the SMF component 334 can periodically aggregate the data in the address space buffers and generate a system total count for each workload class type. For example, if the reporting interval is 15 minutes and there are 16 workload classes, the program code of the SMF component 334 can report 16 counts in each 15-minute interval record. In another embodiment, the program code of the SMF component 334 can generate records for each address space. These records can include count counts for all workload classes. The program code of the SMF component 334 can generate these records periodically (e.g., every 15 minutes) or at job end.

Effectively managing a distributed computing system, including a cloud computing system, is aided by accurate resource utilization information, including how much CPU time was spent in certain software libraries. Program code executing on one or more processors in the computer system can utilize the records previously generated and stored in the database 336 to determine how much CPU time was spent in certain software libraries and/or to determine system utilization information. For example, a program code can determine, for a given interval, how much CPU resources were used by programs running in the computing system, what percentage of the CPU resources can be attributed to a group of workload classes, and/or a combination thereof. Upon generating this utilization information, the program code can automatically re-allocate resources to maintain or improve processing efficiencies, and/or automatically generate an alert to a resource allocator suggesting an approach to improve resource utilization and/or processing efficiency based on the data.

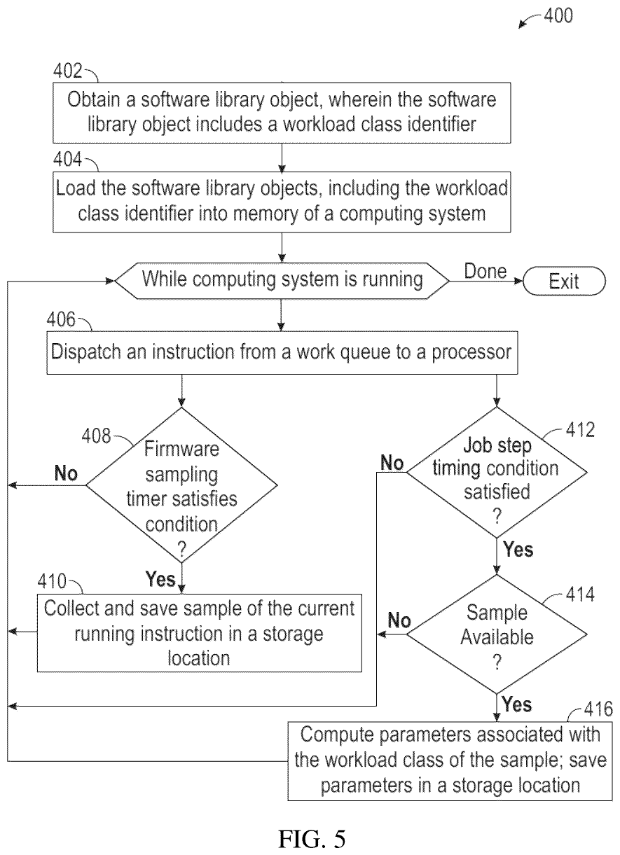

FIG. 5 is a workflow 400 that illustrates various aspects of the examples herein, specifically, determining software accesses and/or system utilization information in a computing environment. This workflow 400 can be performed by program code and/or machine code comprising the software usage determining component 165 illustrated herein. The workflow 400 commences when program code executing on one or more processors obtains a software library object (e.g., software object 310). The software library object includes a workload class identifier (e.g., workload class identifier 314) (402). Program code loads the software library object, including the workload class identifier, into memory of a computing system (404). While the computing system is running, the program code can dispatch (e.g., via dispatcher 322) an instruction from a work queue (e.g., work queue 324) to a processor in the computing system (406). The program code determines if a firmware sampling timer (e.g., firmware sampling timer 328) satisfied a predetermined condition (408). This condition can include whether a predetermined amount of time has elapsed.

Based on determining that the firmware sampling timer satisfied the predetermined condition, then program code (e.g., via firmware sampling routine 326) collects, interprets, and saves a sample of the current running instruction (along with its associated workload class identifier) in a storage location (410). Based on determining that the firmware sampling timer does not satisfy the predetermined condition, then program code continues dispatching instructions (e.g., via the dispatcher 322) (406).

When the program code dispatches (e.g., via dispatcher 322) an instruction from a work queue (e.g., work queue 324) to a processor in the computing system (406), the program code can also determine if a condition for invoking job step timing is satisfied (412). For example, hardware may produce an interrupt (e.g., from CPU timer, I/O event, or a combination thereof) and provide control to the operating system interrupt handler. When this occurs, control is returned to the dispatcher and job step timing is invoked. Based on the condition being satisfied (an interrupt occurring to enable sampling), the program code determined whether a sample is available via job step timing (414). For example, when job step timing is invoked, the processor can be instructed to check for a sample. If the program code determines that a sample is available, then the program code computes one or more parameters associated with the workload class of the sample and saves the parameters in a storage location (e.g., workload accounting area 330) (416). If the program code determined that a sample is not available, the program code can continue dispatching instructions (e.g., via the dispatcher 322) (406). I some examples, the program code utilizes the sampling data to automatically reconfigure processing resources within the computing system to provide resources to process software objects with a high number of accessing, when compared to other software objects. Additionally, the program code can allocate resources based on the classes with the most accesses.

While the foregoing is directed to embodiments of the present invention, other and further embodiments of the invention may be devised without departing from the basic scope thereof, and the scope thereof is determined by the claims that follow.

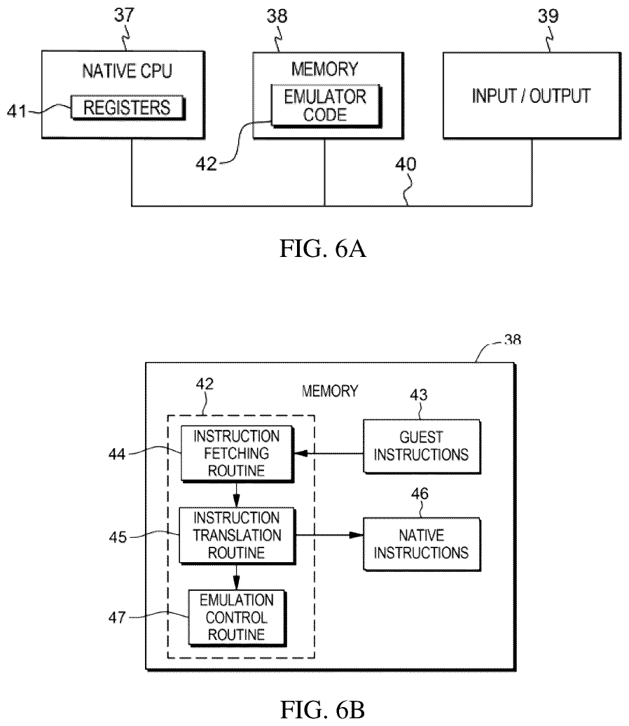

Although one or more examples of a computing environment to incorporate and use one or more aspects of the present disclosure are described herein, FIGS. 6A-6B depict another embodiment of a computing environment to incorporate and use one or more aspects of the present disclosure.

Referring, initially, to FIG. 6A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 6B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native central processing unit 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native central processing unit 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native central processing unit or by using locations in memory 38. In embodiments, guest instructions 43, native instructions 46 and emulator code 42 may reside in the same memory or may be disbursed among different memory devices.

An example instruction that may be emulated is a firmware sampling instruction, and other instructions discussed herein, in accordance with one or more aspects of the present disclosure. Other instructions are also possible.

The computing environments described herein are only examples of computing environments that can be used. One or more aspects of the present disclosure may be used with many types of environments. The computing environments provided herein are only examples. Each computing environment is capable of being configured to include one or more aspects of the present disclosure. For instance, each may be configured to implement control mode processing and/or to perform one or more other aspects of the present disclosure. Software and hardware performance is improved by eliminating extra code and executing time and preventing errors (e.g., for not initializing the unused fields with zeros).

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet a further aspect, a process for integrating computing infrastructure comprising integrating computer-readable code into a computer system may be provided. The computer system comprises a computer-readable medium, in which the computer medium comprises one or more embodiments. The code in combination with the computer system is capable of performing one or more embodiments.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media; and
program instructions, collectively stored in the set of one or more computer-readable storage media, for causing at least one computing device to perform computer operations including:
obtaining one or more software objects, each comprising a workload type attribute and a software library comprising a set of instructions;
loading the set of instructions for each software object into a memory of a computing system and storing the workload type attribute for each software object as metadata of the software library for the software object;
during runtime of the computing system, deploying a first hardware instruction to trigger a firmware process to sample, at each interval of timed pre-configured intervals, instructions from the sets of instructions of the one or more software objects being executed during the interval by one or more processors of the computing system;
deploying a second hardware instruction to obtain and store samples from the firmware process in the memory;
generating, based on analyzing the stored samples, execution parameters associated with each sample;
utilizing the execution parameters and the metadata to determine accesses to the software libraries in the computing system, by workload type attribute; and
based on determining the accesses, automatically implementing an action related to at least one software object in the computing system.

2. The computer program product of claim 1, the computer operations further comprising:
generating the one or more software objects, the generating comprising:
for each software object,
obtaining the object code of the software library from a storage medium;
analyzing the object code to determine a workload type attribute; and
utilizing a binder to link the object code to the workload type attribute, wherein the object code with the linked workload type attribute comprises the software object.

3. The computer program product of claim 1, wherein the workload type attribute indicates a workload class of the software library.

4. The computer program product of claim 1, wherein deploying the second hardware instruction to obtain and store samples from the firmware process in the memory comprises:
determining an interrupt has occurred;
based on determining that the interrupt has occurred, controlling a second firmware process to issue and extract instruction to collect pending samples.

5. The computer program product of claim 1, wherein the action comprises generating and transmitting a report based on the generated execution parameters.

6. The computer program product of claim 1, wherein the action comprises automatically adjusting allocation of a resource of the computing system based on the generated execution parameters.

7. The computer program product of claim 1, wherein storing the workload type attribute comprises storing the workload type attribute in a dynamic address translation table.

8. The computer program product of claim 1, wherein the second hardware instruction controls a second firmware process to obtain and store the samples from the firmware process at a second pre-determined interval.

9. The computer program product of claim 1, wherein the execution parameters for each software library each comprise an indication of an amount of time the software library was accessed by a processor of the one or more processors or the computing system.

10. The computer program product of claim 8, wherein the second firmware process determines, at each second pre-determined, if a sample was taken by the firmware process during the second pre-determined interval, and wherein based on determining that the sample was taken, incrementing a count associated with the workload class in the sample.

11. A computer system comprising:
at least one computing device;
a set of one or more computer-readable storage media; and
program instructions, collectively stored in the set of one or more computer-readable storage media, for causing the at least one computing device to perform computer operations including:
obtaining one or more software objects, each comprising a workload type attribute and a software library comprising a set of instructions;
loading the set of instructions for each software object into a memory of a computing system and storing the workload type attribute for each software object as metadata of the software library for the software object;
during runtime of the computing system, deploying a first hardware instruction to trigger a firmware process to sample, at each interval of timed pre-configured intervals, instructions from the sets of instructions of the one or more software objects being executed during the interval by one or more processors of the computing system;
deploying a second hardware instruction to obtain and store samples from the firmware process in the memory;
generating, based on analyzing the stored samples, execution parameters associated with each sample;
utilizing the execution parameters and the metadata to determine accesses to the software libraries in the computing system, by workload type attribute; and
based on determining the accesses, automatically implementing an action related to at least one software object in the computing system.

12. The computer system of claim 11, the computer operations further comprising:
generating the one or more software objects, the generating comprising:
for each software object,
obtaining the object code of the software library from a storage medium;
analyzing the object code to determine a workload type attribute; and
utilizing a binder to link the object code to the workload type attribute, wherein the object code with the linked workload type attribute comprises the software object.

13. The computer system of claim 11, wherein the workload type attribute indicates a workload class of the software library.

14. The computer system of claim 11, wherein deploying the second hardware instruction to obtain and store samples from the firmware process in the memory comprises:
determining an interrupt has occurred;
based on determining that the interrupt has occurred, controlling a second firmware process to issue and extract instruction to collect pending samples.

15. The computer system of claim 11, wherein the action comprises generating and transmitting a report based on the generated execution parameters.

16. The computer system of claim 11, wherein the action comprises automatically adjusting allocation of a resource of the computing system based on the generated execution parameters.

17. The computer system of claim 11, wherein storing the workload type attribute comprises storing the workload type attribute in a dynamic address translation table.

18. The computer system of claim 11, wherein the second hardware instruction controls a second firmware process to obtain and store the samples from the firmware process at a second pre-determined interval.

19. The computer system of claim 11, wherein the execution parameters for each software library each comprise an indication of an amount of time the software library was accessed by a processor of the one or more processors or the computing system.

20. A computer-implemented method comprising:
requesting execution of an instruction to perform an action defined by the instruction, wherein the executing the instruction includes:
obtaining one or more software objects, each comprising a workload type attribute and a software library comprising a set of instructions;
loading the set of instructions for each software object into a memory of a computing system and storing the workload type attribute for each software object as metadata of the software library for the software object;
during runtime of the computing system, deploying a first hardware instruction to trigger a firmware process to sample, at each interval of timed pre-configured intervals, instructions from the sets of instructions of the one or more software objects being executed during the interval by one or more processors of the computing system;
deploying a second hardware instruction to obtain and store samples from the firmware process in the memory;
generating, based on analyzing the stored samples, execution parameters associated with each sample;
utilizing the execution parameters and the metadata to determine accesses to the software libraries in the computing system, by workload type attribute; and
based on determining the accesses, automatically implementing an action related to at least one software object in the computing system.
